(19) United States
(12) Patent Application Publication
(10) Pub. No.: US 2013/0341964 A1
(43) Pub. Date: Dec. 26, 2013

(54) MOTOR VEHICLE BODY

(71) Applicant: GM GLOBAL TECHNOLOGY OPERATIONS LLC, Detroit, MI (US)

(72) Inventors: Stefan WOLFF, Hochheim (DE); Joachim SCHAEFER, Darmstadt (DE)

(73) Assignee: GM GLOBAL TECHNOLOGY OPERATIONS LLC, Detroit, MI (US)

(21) Appl. No.: 13/692,923

(22) Filed: Dec. 3, 2012

(30) Foreign Application Priority Data
Dec. 3, 2011 (DE) 20 2011 109 253.8
Dec. 17, 2011 (DE) 10 2011 121 401.5

(51) Int. Cl. B60R 21/34

(52) U.S. Cl. CPC B60R 21/34
USPC 296/187.04

(57) ABSTRACT

A motor vehicle body is provided. The motor vehicle body includes a front bonnet, a front window rising out of a rear margin of the front bonnet and a cross member extending in width direction of the front window. A front flange of the cross member supports a front lower margin of the front window, a rear flange being supported on a structural element of the body, and a first intermediate piece extends from an upper rear margin of the front flange towards the rear flange. The rear flange is widened towards the front by a second intermediate piece beyond a support area of the structural element. The intermediate pieces are linked via a bending zone that is convex towards the engine compartment.

### CROSS-REFERENCE TO RELATED APPLICATION

This application claims priority to German Patent Application No. 20 2011 109 253.8, filed Dec. 3, 2012, and this application claims priority to German Patent Application No. 10 2011 121 401.5, filed Dec. 17, 2012, which are each incorporated herein by reference in their entirety.

### TECHNICAL FIELD

The present disclosure relates to a motor vehicle body having a front bonnet, a front window rising out of a rear margin of the front bonnet and a cross member supporting a front lower margin of the front window.

### BACKGROUND

From DE102007012830 A1 a motor vehicle is known, with which a cross member supporting the front window is assembled of two support parts connected to each other on their front and rear margins. The upper support part is curved upwards in cross section, with a front portion supporting a front margin of the front window, rising against the travelling direction, a substantially horizontal middle portion and a rear portion that is steeply dropping against the travelling direction. When this vehicle in traffic touches a pedestrian, the latter normally impacts the bonnet obliquely from above while it pivots about an axis which is approximately located on the front margin of the bonnet. With an adult pedestrian of normal size, the head may mostly contact the front window in this case, and may deform the cross member located below. Thanks to a bend in its front portion the upper support part is initially yielding somewhat easily. The resistance of the cross member however may increase when the lower support part is also subjected to the deformation, or when the deformation reaches the rear portion of the upper support part, which is oriented almost parallel to the impact direction and therefore may put up a high resistance to the deformation. This may influence the values of the HIC (head injury criterion) in the case of an impact on the known cross member.

Thus, it may be desirable to provide a motor vehicle body having a cross member supporting a front window, with which the risk of injury upon the impacting of a head on the cross member is reduced. In addition, other objects, desirable features and characteristics will become apparent from the subsequent summary and detailed description, and the appended claims, taken in conjunction with the accompanying drawings and this background.

### SUMMARY

According to various exemplary embodiments, provided is a motor vehicle body having a front bonnet, a front screen rising out of a rear margin of the front bonnet and a cross member extending in width direction of the front window, from which a front flange supports a front lower margin of the front window, a rear flange is supported on a structural element of the body and a first intermediate piece extends from an upper rear margin of the front flange to the rear flange, the rear flange being widened towards the front beyond a support area of the structural element by a second intermediate piece and the intermediate pieces being linked via a bending zone that is convex towards the engine compartment. In that the second intermediate piece upon the impacting of a head on the lower region of the front window bends along a front edge of the support area and pivots downwards, it facilitates the yielding of the cross member under the load of an impact and thus a reduction of the HIC-value.

In order to be able to be effectively deformed by an impact force substantially acting from above, the second intermediate piece is generally oriented horizontally. In the simplest case, it can extend in a line with the rear flange.

The first intermediate piece is generally arched in cross section and has a portion vertically striking the bending zone from above. While during an impact the second piece is bent downwards, the first piece can dissipate further impact energy through upsetting deformation of the arch.

In order to ensure an adequate yielding of the second intermediate piece, the second intermediate piece should not be too narrow. In one example, its extension in vehicle longitudinal direction should amount to at least one third of the extension in the same direction of the first intermediate piece.

In order to ensure a reproducible bending of the second intermediate piece with the energy consumption remaining the same, the support area should generally have a straight front edge at least in sections.

It is also advantageous, in one example, for the reproducibility of the bending when the bending zone runs parallel to the front edge.

A free space should extend below the second intermediate section in order to offer the second intermediate section space for yielding backwards.

The cross member generally extends in a freely supporting manner between front and rear flange.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 is a perspective view of a part of a motor vehicle body according to one exemplary embodiment of the present disclosure and of an impactor simulating the impact of the head of a pedestrian on the body;

FIG. 2 is a schematic cross section through the body parts shown in FIG. 1 and their substructure;

FIG. 3 is a top view of a cross member and a structural element supporting said cross member according to another exemplary embodiment of the present disclosure; and

FIG. 4 is a top view according to another exemplary embodiment of the present disclosure that is analogous to FIG. 3.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

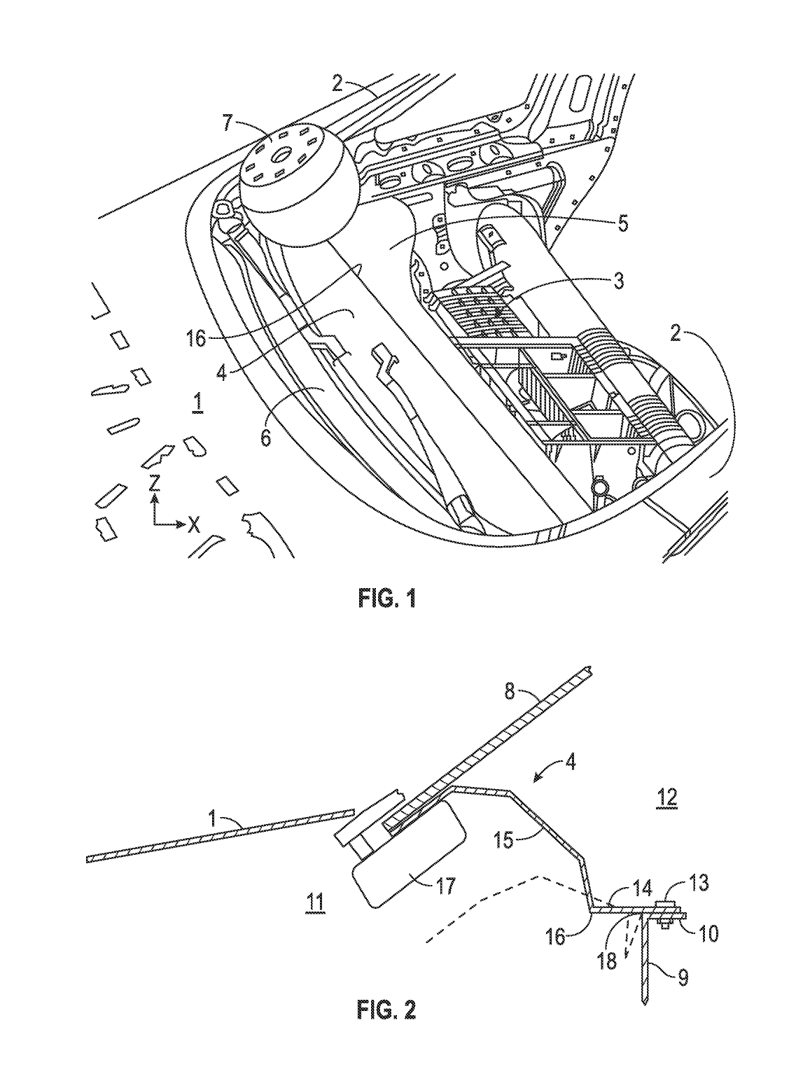

FIG. 1 shows a perspective view of a part of a motor vehicle body on which the present disclosure is implemented. Visible is the rear region of a front bonnet 1 and a window opening following thereon which on the finished vehicle receives a front window, flanked by A-pillars 2. A dashboard covering has been omitted in FIG. 1 in order to be able to show installations 3 of the dashboard located below and a cross member 4 formed from a single-layered sheet metal cutting, which on the finished vehicle are concealed under the dashboard covering. A rear flange 5 of the cross member 4 supports itself on the upper edge of a separating wall that is not visible in the Figure, which extends between passenger cell and engine compartment. An obliquely inclined front flange 6 of the cross member supports a front lower margin of the front window.

An impactor 7 shown above the cross member 4 shows the position in which, when the vehicle collides with an adult pedestrian of normal size, said pedestrian impacts the front bonnet 1, whose head strikes the body. The impact location is located in a lower region of the front window supported by the front flange 6 of the cross member 4. In order to be able to adhere to the legal HIC-limit values, the cross member 4 must be able to yield under the impact.

FIG. 2 shows a schematic section in vehicle longitudinal direction through the cross member 4 and its surroundings. Visible is a rear region of the front bonnet 1 and a part each of the front window here designated with 8 and the separating wall between engine compartment 11 and passenger cell 12, designated with 9. On an upper edge of the separating wall 9, a horizontal support area 10, for example in the form of a flange unitarily bent down towards the passenger cell 12 from the separating wall 9. On this support area 10 the rear flange 5 of the cross member 4 is fastened being in contact over a large area, for example with the help of a plurality of screws 13.

The rear flange 5 resting on the support area 10 is extended towards the front in a straight line by a horizontal intermediate piece 14, which in a freely supporting manner projects a few centimeters beyond the separating wall 9 into the engine compartment 11. An arched intermediate piece 15 extends from the front flange 6 and meets the intermediate piece 14 at a bending zone 16 at an approximately right angle. The curvature of the arched intermediate piece can be continuously formed or, as shown in FIG. 2, through a sequence of a plurality of segments that are not curved or only slightly so and bending zones located in between. The convex lower side of the arched intermediate piece 15 facing the engine compartment offers space for accommodating a windscreen wiper motor 17.

Below this windscreen wiper motor 17 and the intermediate piece 14, space has been kept clear in order to make possible an evasive movement of the wiper motor 17 with simultaneous upsetting deformation of the intermediate piece 15, bending of the intermediate piece 14 along the front edge of the support area 10 and simultaneous narrowing of the angle defined by the bending zone 16 in the event of a head impact on the front window 8, as is shown in FIG. 2 as an interrupted line contour.

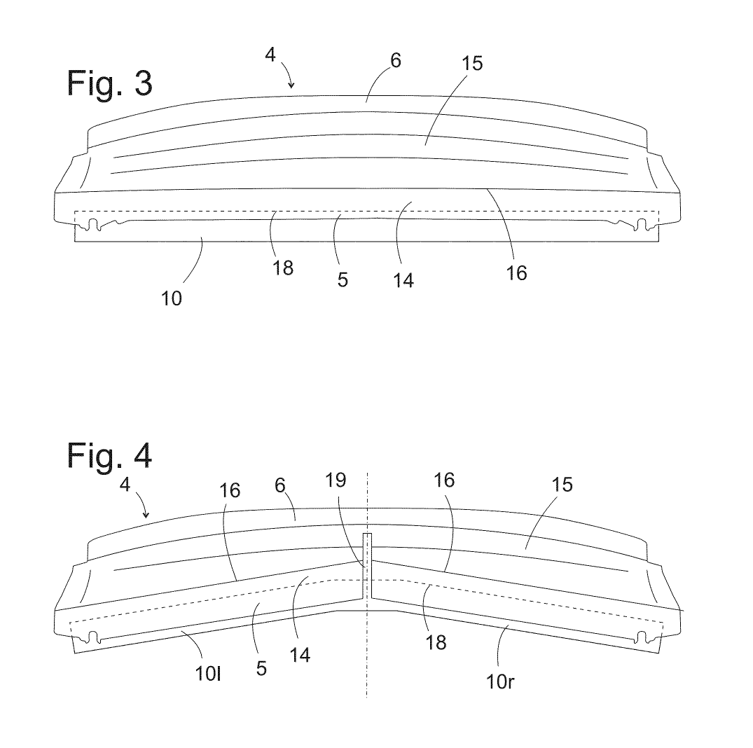

FIG. 3 shows a top view of the cross member 4 and the support area 10 according to one exemplary embodiment of the present disclosure. A front edge 18 of the support area 10 which is concealed by the cross member 4 in top view and therefore only represented in the Figure as an interrupted line extends in a straight line over almost the entire width of the cross member 4. The bending zone 16 runs parallel to the front edge 18. The straight-line shape of the intermediate piece 14 resulting from this allows it to yield when a body impacts the front window 8 without any shearing or upsetting deformation in vehicle transverse direction of the material of the cross member 4 being required in this case. Thus it is ensured that once the front window 8 has shattered under the impact and because of this an initial resistance to the deformation is overcome, the front window 8 at the point of impact of the impactor 7 yields continuously and subject to exerting a reproducible deceleration force on the impactor 7.

The cross member 4 extends over the entire width of the passenger cell 12. The front flange 6 in the top view is slightly curved to fit the shape of the front window 8 and its extension in width direction of the vehicle is slightly smaller than that of the curved intermediate piece 15, so that the front flange 6 can find space between the A-pillars 2 and support the front window 8 over its entire extension.

FIG. 4 shows a top view that is analogous to FIG. 3 according to another exemplary embodiment. The support area 10 in this case is not elongated exactly in vehicle transverse direction as with the prior exemplary embodiment, but comprises two sections 101, 10r elongated in a straight line, each of which run from the sides obliquely forward to a longitudinal center plane of the vehicle—drawn in as dash-dotted line where they meet each other at an obtuse angle. The cross member 4 is provided with a slit 19, which extends along the longitudinal center plane through the rear flange 5, the intermediate piece 14 and the bending zone 16 as far as into the curved intermediate piece 15. When the intermediate piece 14 locally yields downwards under an impact, the slit 19 enables the bending zone 16—which is stiff in vehicle transverse direction—to come near the longitudinal center plane without a local upsetting deformation of the cross member 4 in vehicle transverse direction being required for this purpose, which would require as a prerequisite a high initial resistance that is difficult to reproduce and possibly lead to the HIC-limit value being exceeded.

Even without a corresponding Figure it can be easily followed that the support area 10 could also be composed of more than two straight-line sections in order to approximate an arched curve similar to that of the front flange 6 also on the rear edge of the cross member 4, wherein the cross member should then comprise a slit reaching from the rear edge as far as over the bending zone towards the front corresponding to the slit 19 between each two such straight-line sections.

According to another exemplary embodiment, one or a plurality of such slits can also be provided on a cross member 4 with straight rear flange 5 as shown in FIG. 3. In that these slits divide the intermediate piece 14 of such a cross member over its width into a plurality of sections that are separated from each other, it enables these sections to yield largely independently of one another under the loading of an impact. While the intact front window 8 distributes a force acting on it in width direction over a plurality of sections of the intermediate piece 15 so that the intact window is supported by the cross member 4 in a secure and fixed manner, this distribution action is largely cancelled when after the impact of the impactor 7 the front window 8 is shattered. Thus, the impulse of the impactor 7 then concentrates on one or two of the sections of the cross member 4. While the load capacity of a cross member 4 slit in this way does not differ substantially from that of the non-slit cross member 4 of FIG. 3 with intact front window 8, the yielding after the destruction of the front window 8 is increased so that the deformation movement freedom of the intermediate piece 14 can be completely utilized for decelerating the impactor 7.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A motor vehicle body, comprising:
a front bonnet;
a front window rising out of a rear margin of the front bonnet; and
a cross member extending in width direction of the front window that includes a front flange that supports a front lower margin of the front window, a rear flange that is supported on a structural element of the body and a first intermediate piece that extends from an upper rear margin of the front flange towards the rear flange,
wherein the rear flange is widened towards the front by a second intermediate piece beyond a support area of the structural element and the first intermediate piece and second intermediate piece are linked via a bending zone that is convex towards the engine compartment.

2. The motor vehicle body according to claim 1, wherein the second intermediate piece is horizontally oriented.

3. The motor vehicle body according to claim 1, wherein the first intermediate piece is arched in cross section and meets the bending zone vertically from above.

4. The motor vehicle body according to claim 3, wherein below the first intermediate piece a wiper motor is accommodated.

5. The motor vehicle body according to claim 1, wherein the extension in vehicle longitudinal direction of the second intermediate piece amounts to at least one third of the extension in vehicle longitudinal direction of the first intermediate piece.

6. The motor vehicle body according to claim 1, wherein the support area has a front edge that is straight at least in sections.

7. The motor vehicle body according to claim 6, wherein the bending zone runs parallel to the front edge.

8. The motor vehicle body according to claim 1, wherein a free space extends below the second intermediate piece.

9. The motor vehicle body according to claim 1, wherein the cross member extends in a freely supporting manner between the front flange and the rear flange.

10. A motor vehicle, comprising:
a motor vehicle body including a front bonnet, a front window rising out of a rear margin of the front bonnet, and a cross member extending in width direction of the front window that includes a front flange that supports a front lower margin of the front window, a rear flange that is supported on a structural element of the body and a first intermediate piece that extends from an upper rear margin of the front flange towards the rear flange, the cross member extending in a freely supporting manner between the front flange and the rear flange,
wherein the rear flange is widened towards the front by a second intermediate piece beyond a support area of the structural element and the first intermediate piece and second intermediate piece are linked via a bending zone that is convex towards the engine compartment.

11. The motor vehicle according to claim 10, wherein the support area has a front edge that is straight at least in sections.

12. The motor vehicle according to claim 11, wherein the bending zone runs parallel to the front edge.

13. The motor vehicle according to claim 10, wherein a free space extends below the second intermediate piece.

14. The motor vehicle according to claim 10, wherein the second intermediate piece is horizontally oriented.

15. The motor vehicle according to claim 10, wherein the first intermediate piece is arched in cross section and meets the bending zone vertically from above.

16. The motor vehicle according to claim 15, wherein below the first intermediate piece a wiper motor is accommodated.
